(19) United States
(12) Patent Application Publication
(10) Pub. No.: US 2019/0135140 A1
(43) Pub. Date: May 9, 2019

(54) LONGITUDINAL ADJUSTER AND VEHICLE SEAT

(71) Applicant: Adient Luxembourg Holding S.à r.l., Luxembourg (LU)

(72) Inventors: Joachim FLICK, Hueckeswagen (DE); Erik SPRENGER, Wermelskirchen (DE)

(73) Assignee: Adient Luxembourg Holding S.à r.l., Luxembourg (LU)

(21) Appl. No.: 16/096,883

(22) PCT Filed: Apr. 25, 2017
(86) PCT No.: PCT/EP2017/059833

§ 371 Date: Oct. 26, 2018

(30) Foreign Application Priority Data
Apr. 28, 2016 (DE) 10 2016 207 316.8
Aug. 25, 2016 (DE) 10 2016 215 958.5

(51) Int. Cl. B60N 2/08; B60N 2/07

(52) U.S. Cl. CPC B60N 2/0818; B60N 2/0705; B60N 2205/35; B60N 2/0893; B60N 2205/20; B60N 2/0875

(57) ABSTRACT

A vehicle seat longitudinal adjuster includes two pairs of rails (10), each including a seat-mounted upper rail (10a) and a structure-mounted lower rail (10b). A first locking element (16a) and a second locking element (16b) block movement of the upper rail relative to the lower rail. The lower rail has apertures (14) and the upper rail has slot openings (12). The locking elements have tooth projections (18), which are guided in the slot openings, and in a locking position, reach through the slot openings and the apertures. In the locking position, the first locking element engages partially in the apertures for the play-free position of the pair of rails. In the locking position, the second locking element is always fully inserted into the apertures. A vehicle seat (1) has a seat part (3), a backrest (5) which is coupled to the seat part and a longitudinal adjuster.

### CROSS REFERENCE TO RELATED APPLICATIONS

This application is a United States National Phase Application of International Application PCT/EP2017/059833, filed Apr. 25, 2017, and claims the benefit of priority under 35 U.S.C. §119 of German Applications 10 2016 207 316.8, filed Apr. 28, 2016, and 10 2016 215 958.5, filed Aug. 25, 2016, the entire contents of which are incorporated herein by reference.

### TECHNICAL FIELD

The invention relates to a longitudinal adjuster for a vehicle seat, which longitudinal adjuster comprises two rail pairs which are arranged at a distance from one another and are each constructed from a seat-mounted top rail and a structure-mounted bottom rail, a first locking element and at least one second locking element which are held on the top rail.

### BACKGROUND

A vehicle seat of this generic type and, respectively, a locking apparatus for a longitudinal adjuster for a vehicle seat are known, for example, from DE 100 50 957 A1. For the purpose of longitudinal adjustment, the vehicle seat has a seat rail pair comprising a top rail and a bottom rail, the teeth of a locking element passing through the two walls of said top rail and bottom rail on each side of the locking element. In this locking apparatus, there is only one locking element, which locks with a defined grading.

DE 10 2014 225 426 A1 discloses a longitudinal adjuster for a vehicle seat, comprising at least one bottom rail, at least one top rail which can be displaced in relation to the bottom rail in the longitudinal direction, and at least one locking unit for locking the top rail in relation to the bottom rail. The locking unit further comprises at least two locking elements which, for the purpose of locking the top rail and the bottom rail, engage in said top rail and bottom rail in a blocking manner in steps in such a way that, in a preliminary locking stage, at least one of the locking arrangements preliminarily locks the top rail and the bottom rail in relation to one another with play, and that, in a locking stage, at least one of the locking arrangements locks the top rail and the bottom rail to one another without play.

DE 10 2008 028 688 A1 discloses a locking apparatus for a vehicle seat, comprising at least one locking element which can move relative to at least one mating element, in particular in an engagement direction, and interacts with the mating element in order to lock two components of the vehicle seat to one another, wherein the locking element, by way of at least one tooth, makes contact with the edge region of the mating element and, at least at the surface of the tooth, is coated with at least one covering layer. The covering layer is composed of an organic matrix with incorporated, in particular inorganic, particles.

### SUMMARY OF THE INVENTION

The invention is based on the problem of improving a longitudinal adjuster of the kind mentioned in the introductory part, in particular of increasing the load-bearing capacity, and also of providing a corresponding vehicle seat.

According to the invention, this problem is solved by a longitudinal adjuster, in particular for a vehicle seat, preferably for a vehicle rear seat, comprising two rail pairs which are arranged at a distance from one another. The rail pairs are each constructed from a seat-mounted top rail and a structure-mounted bottom rail, comprising a first locking element and at least one second locking element. The first and the second locking element are held on the top rail and, in a locking position, block a movement of the top rail relative to the bottom rail. The bottom rail has apertures and the top rail has slot-like openings. The first locking element and the at least one second locking element, on the two opposite longitudinal sides thereof, each have tooth-like projections which are guided in the slot-like openings and which, in the locking position, pass through both the slot-like openings and also the apertures, wherein only the first locking element, in the locking position, only partially engages into the apertures for eliminating play of the rail pair, while the at least one second locking element, in its locking position, is always fully inserted into the apertures.

As a result of only the first locking element, in the locking position, only partially engaging into the apertures for eliminating play of the rail pair, while the at least one second locking element, in its locking position, is always fully inserted into the apertures, the maximum possible loading capacity can be ensured by the locking elements. A general manner of operation of a locking arrangement of seat rails of a vehicle seat by means of locking elements of this kind is known, for example, from DE 100 50 957 A1, the disclosure content of said document in this respect, in particular relating to the configuration, dimensioning, arrangement and operation of the locking elements, being expressly incorporated.

Furthermore, a plurality of further locking elements can be provided for further increasing the load-bearing capacity. A total of two to five locking elements are preferably used.

In a further advantageous manner, it can be provided that only a single locking element is used for eliminating play of the top rail in relation to the bottom rail.

The outer dimensions, in particular a length and a width, of the respective locking elements can be configured differently. Furthermore, the number of tooth-like projections on the respective locking elements can be different. Similarly, the outer shape of the tooth-like projections on the locking elements can be configured differently, in particular the tooth-like projections of at least one locking element can be of conical configuration and/or the tooth-like projections of at least one locking element can have laterally beveled side flanks. Within the meaning of the invention, “conically” is generally to be understood as tapering of a circumference, a width or a radius.

The apertures in the bottom rail can be both of tooth-like configuration, for example in the form of a latching comb, with downwardly directed openings or configured in the form of latching holes, in particular with a circumferentially closed edge.

The problem is further solved by a vehicle seat, in particular a vehicle rear seat, having a seat part, a backrest which is connected in an articulated manner to the seat part, and an above-described longitudinal adjuster.

In summary, locking is performed using two independent latching elements. The first latching element can be embodied like the example described in the prior art according to DE 100 50 957 A1, wherein the two profiles are fixed to one another without play after locking. The engagement depth can be dependent on the existing individual part tolerances, this also being influenced to a certain extent by the locking strength of the latching elements. The second latching element can be configured such that it engages fully into the tooth gaps of the bottom rail, that is to say as far as the base of the tooth gaps, during locking. The second latching element can therefore preferably be free of influences of a tolerance chain and always in full engagement. The strength of the two latching elements therefore adds to a total strength of the locking arrangement. The number of teeth of the two locking elements can be virtually freely selected, according to requirements (required locking strength). Unlocking of the two locking plates can be performed by way of an unlocking system, as is described in DE 10 2015 220 262 A1 for example, the disclosure content of said document in this respect being expressly incorporated.

Before a preferred refinement of the invention is described in greater detail in the following text using drawings, it is to be noted first of all that the invention is not restricted to the described components or the described method steps. Furthermore, the terminology which is used is also not of a restrictive nature, but rather merely has an exemplary character. If the singular is used in the following text in the description and the claims, in each case the plural is also included here if the context does not explicitly rule this out. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which the preferred embodiment of the invention is illustrated.

### BRIEF DESCRIPTION OF THE DRAWINGS

In the drawings:

FIG. 1 shows a schematic illustration of a vehicle seat;

FIG. 2 shows a perspective view of a rail pair;

FIG. 3 shows a schematic cross-sectional illustration of the rail pair from FIG. 2;

FIG. 4 shows a sectional illustration of a detail of the rail pair from FIG. 2 in an unlocked position, and

FIG. 5 shows a sectional illustration of a detail of the rail pair from FIG. 2 in a locked position.

### DESCRIPTION OF PREFERRED EMBODIMENTS

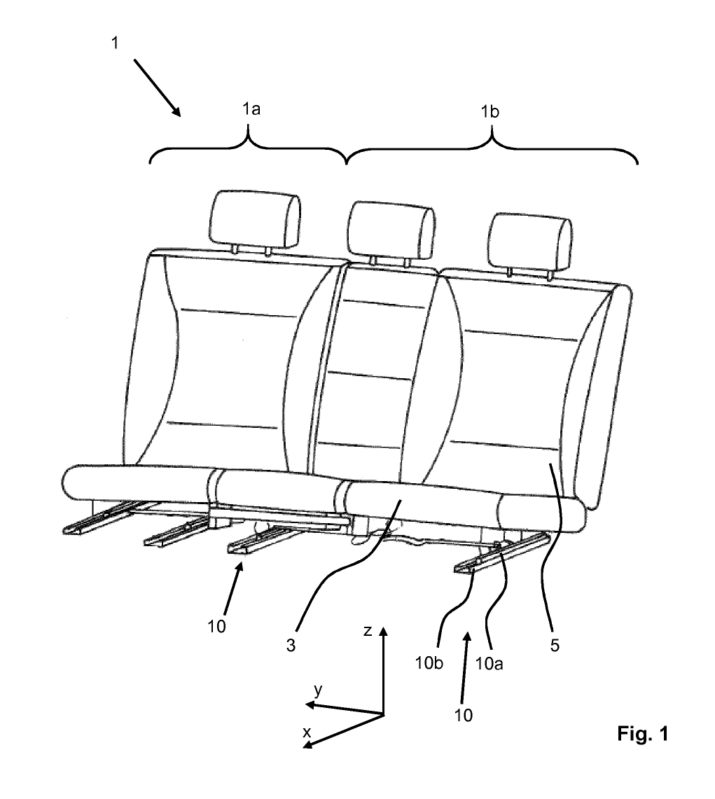

Referring to the drawings, the vehicle seat 1 schematically illustrated in FIG. 1, in the present case a vehicle rear seat, will be described below using three spatial directions which run perpendicular to one another. In the case of a vehicle seat 1 which is installed in the vehicle, a longitudinal direction x runs largely horizontally and preferably parallel to a vehicle longitudinal direction which corresponds to the usual direction of travel of the vehicle. A transverse direction y, which runs perpendicular to the longitudinal direction x, is likewise oriented horizontally in the vehicle and runs parallel to a vehicle transverse direction. A vertical direction z runs perpendicular to the longitudinal direction x and perpendicular to the transverse direction y. In the case of a vehicle seat 1 which is installed in the vehicle, the vertical direction z runs parallel to the vehicle vertical axis.

The position specifications and direction specifications which are used, such as front, rear, top and bottom, relate to a viewing direction of an occupant seated in the vehicle seat 1 in a normal seat position, wherein the vehicle seat 1 is installed in the vehicle and is oriented in a use position suitable for passenger transport with an upright backrest 5 and in the direction of travel as is customary. However, the vehicle seat 1 according to the invention can also be installed with a different orientation, for example transversely in relation to the direction of travel.

The vehicle seat 1 illustrated in FIG. 1 is divided into two regions, a first part 1a and a second part 1b. The second part 1b comprises two seats, while the first part 1a provides only one seat. Subdividing the total seat width into a width of the first part 1a of 40% of the total seat width and a width of the second part 1b of 60% of the total seat width corresponds to a customary division. Each of the two parts 1a, 1b has a seat part 3 and also a backrest 5 which is mounted in an articulated manner on the respective seat part 3.

The present longitudinal adjuster according to the invention is preferably connected to the second part 1b for use since said second part has to withstand a higher loading in the event of a crash on account of its greater width. The two rail pairs 10 which are arranged at a distance from one another and parallel to one another each have a top rail 10a and a bottom rail 10b, which top rail and bottom rail mutually engage around one another and are mounted such that they can be displaced relative to one another.

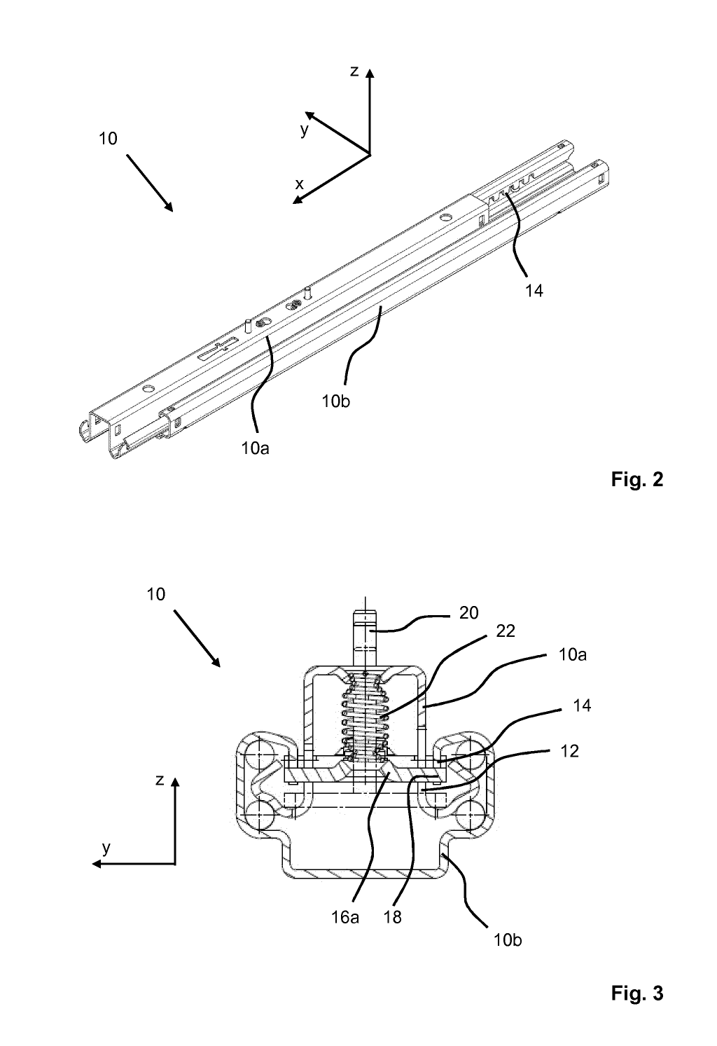

The longitudinal adjuster shown in FIG. 2 has the seat-mounted top rail 10a and the structure-mounted bottom rail 10b. FIG. 3 illustrates a cross-sectional view of a rail pair 10 of the longitudinal adjuster in further detail. The rail pair 10 has a first locking element 16a which is held on the top rail 10a and, offset in relation to the first locking element 16a in the longitudinal direction x, a second locking element 16b—not shown in FIG. 3 for reasons of illustration—which is likewise held on the top rail 10a. The two locking elements 16a, 16b have, on the two opposite longitudinal sides thereof, tooth-like projections 18 which protrude parallel to the transverse direction y. The top rail 10a has slot-like openings 12 in which the tooth-like projections 18 of the two locking elements 16a, 16b are guided.

The bottom rail 10b has tooth-like apertures 14 which the tooth-like projections 18 of the two locking elements 16a, 16b at least partially enter when the two locking elements 16a, 16b are moved to a locking position in which a movement of the top rail 10a relative to the bottom rail 10b is blocked. The apertures 14 can preferably have at least one beveled side face, in particular the apertures 14 can be embodied in a conical manner, in order to facilitate entry of the projections 18 and to render possible elimination of play between the top rail 10a and the bottom rail 10b.

For the purpose of moving the two locking elements 16a, 16b from the locking position to the unlocking position, a guide pin 20 is connected to the locking elements 16a, 16b in each case. The guide pin 20 is guided in a linear manner in a passage opening of the top rail 10a. A return spring 22 is provided in each case for the purpose of moving the two locking elements 16a, 16b from the unlocking position to the locking position.

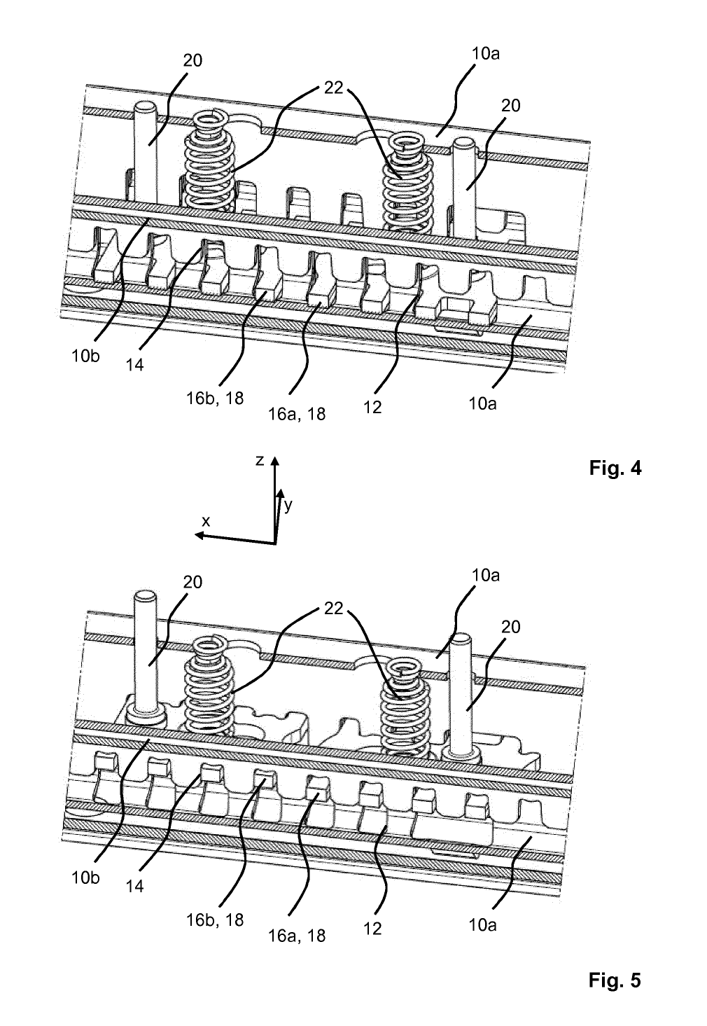

FIG. 4 shows an illustration of a detail of a longitudinal section of the rail pair from FIG. 2 in an unlocked position. The two locking elements 16a, 16b are moved downward to the maximum extent, so that said locking elements rest on a base section of the slot-like openings 12 of the top rail 10a. The tooth-like projections 18 of the two locking elements 16a, 16b are therefore at a maximum distance from the tooth-like apertures 14 of the bottom rail 10b and release the rail pair 10 in the longitudinal direction.

FIG. 5 shows an illustration of a detail of a longitudinal section of the rail pair from FIG. 2 in a locked position. The first locking element 16a, illustrated on the right-hand side in the Figure, only partially enters the apertures 14, specifically until in each case one of the tooth-like projections 18 comes into contact with the bottom rail 10b and with the top rail 10a so as to eliminate play. The first locking element 16a now eliminates play, as is described in DE 100 50 957 A1, the disclosure content of which in this respect is hereby expressly incorporated. The engagement depth is therefore dependent on the tolerances of the play-eliminating tooth-like projections 18, of the slot-like opening 12 in the top rail 10a and of the apertures 14 of the bottom rail 10b. The locking strength which can be achieved is dependent to a certain extent on the immersion depth of the tooth-like projections 18 of the locking element 16a, 16b into the tooth-like apertures 14 of the bottom rail 10b which, in turn, is dependent on an angle of the side faces in relation to one another.

The second locking element 16b, illustrated on the left-hand side in the Figure, does not have a play-eliminating function. The immersion depth is limited by a tooth base of the tooth-like apertures 14 of the bottom rail 10b. The second locking element 16b is therefore configured, always by the maximum possible immersion depth achieved in the locked state, to also provide or to achieve the maximum possible locking strength for the second locking element 16b.

The features which are disclosed in the preceding description, the claims and the drawings can be of significance both individually and in combination for the implementation of the invention in its various refinements.

Although the invention has been described in detail in the drawings and the preceding description, the descriptions are to be understood to be illustrative and exemplary and not restrictive. In particular, the selection of the proportions shown in the drawings of the individual elements is not to be interpreted as required or restrictive. Furthermore, the invention is not restricted to the above-described exemplary embodiments, in particular. Further variants of the invention and their implementation can be gathered by a person skilled in the art from the preceding disclosure, the figures and the claims.

Terms such as “comprise”, “have”, “contain”, “include” and the like which are used in the claims do not rule out further elements or steps. The use of the indefinite article does not rule out a plural. A single device can carry out the functions of a plurality of units or devices mentioned in the claims.

While specific embodiments of the invention have been shown and described in detail to illustrate the application of the principles of the invention, it will be understood that the invention may be embodied otherwise without departing from such principles.

1. A longitudinal adjuster for a vehicle seat, the longitudinal adjuster comprising:
two rail pairs, which rail pairs are arranged at a distance from one another, each rail pair comprising a seat-mounted top rail and a structure-mounted bottom rail;
a first locking element held on the top rail; and
at least one second locking element held on the top rail, wherein in a locking position, the first locking element and the at least one second locking element block a movement of the top rail relative to the bottom rail, wherein the bottom rail has apertures and the top rail has slot openings, wherein the first locking element and the at least one second locking element, on the two opposite longitudinal sides thereof, have tooth projections which are guided in the slot openings and which, in the locking position, pass through both the slot openings and also the apertures, where only the first locking element, in the locking position, only partially engages into the apertures for eliminating play of the rail pair, while the at least one second locking element, in the locking position, is always fully inserted into the apertures and wherein an outer dimension of the first locking element is configured differently from an outer dimension of the second locking element.

2. The longitudinal adjuster as claimed in claim 1, further comprising further locking elements.

3. The longitudinal adjuster as claimed in claim 2, wherein the locking elements are arranged one behind the other in a longitudinal direction.

4. The longitudinal adjuster as claimed in claim 1, wherein the first locking element and the at least one second locking element comprise a total of two to five locking elements.

5. (canceled)

6. The longitudinal adjuster as claimed in claim 1, wherein a length and a width of the respective locking elements are configured differently.

7. The longitudinal adjuster as claimed in claim 1, wherein a number of tooth projections on the respective locking elements is configured differently.

8. The longitudinal adjuster as claimed in claim 1, wherein an outer shape of the tooth projections on the respective locking elements is configured differently.

9. The longitudinal adjuster as claimed in claim 8, wherein the tooth projections of at least one locking element parallel to a transverse direction are of conical configuration.

10. The longitudinal adjuster as claimed in claim 8, wherein the tooth projections of at least one locking element have, as viewed in a transverse direction, laterally beveled side flanks.

11. The longitudinal adjuster as claimed in claim 1, further comprising a centrally arranged return spring, wherein the locking elements are each prestressed in a direction of the locking position by means of the centrally arranged return spring.

12. The longitudinal adjuster as claimed in claim 1, further comprising a guide pins arranged eccentrically in a longitudinal direction, wherein the locking elements are each guided linearly in a vertical direction by means of the guide pins.

13. The longitudinal adjuster as claimed in claim 12, wherein the guide pins are guided in passage openings of the top rail.

14. A vehicle seat further comprising:
a seat part;
a backrest connected in an articulated manner to the seat part; and
a longitudinal adjuster comprising two rail pairs, which rail pairs are arranged at a distance from one another, each rail pair comprising a seat-mounted top rail and a structure-mounted bottom rail, a first locking element held on the top rail and at least one second locking element held on the top rail and, wherein in a locking position, the first locking element and the at least one second locking element block a movement of the top rail relative to the bottom rail, wherein the bottom rail has apertures and the top rail has slot openings, wherein the first locking element and the at least one second locking element, on the two opposite longitudinal sides thereof, have tooth projections which are guided in the slot openings and which, in the locking position, pass through both the slot openings and also the apertures, wherein only the first locking element, in the locking position, only partially engages into the apertures for eliminating play of the rail pair, while the at least one second locking element, in the locking position, is always fully inserted into the apertures and wherein an outer dimension of the first locking element is configured differently from an outer dimension of the second locking element.

15. The vehicle seat as claimed in claim 14, wherein the vehicle seat has a first part and a second part, wherein a total seat width is divided in a ratio of 40:60 between the first part and the second part.

16. The vehicle seat as claimed in claim 14, wherein a length and a width of the respective locking elements are configured differently.

17. The vehicle seat as claimed in claim 14, wherein a number of tooth projections on the respective locking elements is configured differently.

18. The vehicle seat as claimed in claim 14, wherein an outer shape of the tooth projections on the respective locking elements is configured differently.

19. The vehicle seat as claimed in claim 18, wherein the tooth projections of at least one locking element parallel to a transverse direction are of conical configuration.

20. The vehicle seat as claimed in claim 18, wherein the tooth projections of at least one locking element have, as viewed in the transverse direction, laterally beveled side flanks.
